(19) United States
(12) Patent Application Publication
(10) Pub. No.: US 2023/0254750 A1
(43) Pub. Date: Aug. 10, 2023

(54) WIDE AREA NETWORK (WAN) AND LOCAL AREA NETWORK (LAN) AGGREGATOR AT UTILITY SERVICE

(71) Applicant: Avista Edge, Inc., Spokane, WA (US)

(72) Inventors: David Gregory Schafer, Spokane, WA (US); Mark Wayne Gustafson, Spokane, WA (US); Yossi Har-nov, Parkland, FL (US)

(21) Appl. No.: 17/669,242

(22) Filed: Feb. 10, 2022

(51) Int. Cl. H04W 40/06; H04B 3/54

(52) U.S. Cl. CPC H04W 40/06; H04B 3/542

(57) ABSTRACT

A system comprising includes a consumer premise equipment (CPE) having a first antenna, a first broadband over powerline (BPL) interface, a first modem module, and a first transceiver. The CPE configured to wirelessly communicate with a first remote device via the first antenna, aggregate a plurality of wide area networks (WANs), and transmit a first signal and a second signal. The system further includes a router having a second antenna, a second PBL interface, a second modem module, and a second transceiver. The router is configured to receive the first signal and the second signal, aggregate the first signal and the second signal to provide a local area network (LAN), and wirelessly communicate with a second remote device via the second antenna.

### BACKGROUND

The proliferation of the Internet has resulted in individuals and business becoming more connected. The demand for services available on the Internet, and the availability of devices to access the Internet, has correspondingly increased. Despite this increase, much of the world lacks access to broadband services (e.g., DSL, cable, fiber-optic, satellite, etc.). This need has forced carriers, providers, and equipment manufacturers to develop high throughput solutions, such as fiber-optic networks. However, certain premises may be difficult and/or costly to access.

Additionally, some providers utilize wireless technology to deliver broadband internet. As wireless technology evolves to higher frequencies to increase throughput and capacity, building penetration may become untenable. For example, conventional systems may fail to penetrate structures when wireless signals are attenuated below useful levels.

Further technological improvements may enhance access to broadband services and increase user experiences.

### BRIEF DESCRIPTION OF THE FIGURES

The detailed description is set forth with reference to the accompanying figures. In the figures, the left-most digit(s) of a reference number identifies the figure in which the reference number first appears. The use of the same reference numbers in different figures indicates similar or identical items or features. The systems and devices depicted in the accompanying figures are not to scale and components within the figures may be depicted not to scale with each other.

FIG. 1 illustrates an example environment, showing a base station radio device communicating with a customer premise equipment (CPE), or other user equipment (UE) and/or end user device (EUD), for providing broadband services to a premise, according to an embodiment of the present disclosure. Additionally, the CPE communicatively couples to a router located within the premise for providing broadband services to consumer device(s) within the premise.

FIG. 2 illustrates an example diagram for providing broadband services to a premise, using conductive and radio frequency (RF) signals, according to an embodiment of the present disclosure.

FIG. 3 illustrates example computing components of the base station radio device, the CPE, and the router of FIG. 1, according to an embodiment of the present disclosure.

FIG. 4 illustrate an example diagram for aggregating multiple wide area network(s) (WANs) for providing a radio frequency signal to a premise, according to an embodiment of the present disclosure.

FIG. 5 illustrates an example process for providing a conductive signal and a radio frequency signal to a router for providing broadband services to a premise, according to an embodiment of the present disclosure.

FIG. 6 illustrates an example process for aggregating a conductive signal and a radio frequency signal for providing broadband services to a premise, according to an embodiment of the present disclosure.

### DETAILED DESCRIPTION

The present disclosure is directed, at least in part, to systems and methods that provide broadband services (e.g., high-speed internet) to a premise. In some instances, the systems and methods discussed herein may use Broadband over Power Line (BPL) technology (alternatively referred to a powerline communication (PCL) and/or internet over power line (IPL)) to deliver broadband services to a variety of premises, such as homes, multi-family units, and/or places of business. Utilizing existing electrical wiring of the premise may alleviate the need to build broadband facilities, structures, and/or route cables to individual premises. In such instances, BPL technology makes use of existing electrical wiring of the premise to penetrate the premise and provide broadband services. Additionally, the systems and methods may mesh wide area networks (WANs) for providing the broadband services wirelessly to the premise. In such instances, the system and methods may aggregate broadband services provided by BPL, with broadband services wirelessly provided by the WAN(s), for providing increased throughput to premise.

In some instances, the system(s) and method described herein include a plurality of base station radio devices that may be disposed atop vertical structures (e.g., utility poles and street lights) and which communicate with customer premise equipment (CPEs) disposed at the premise. The base station radio devices may communicatively couple to an internet service provider (ISP), wide area network (WAN), and/or service provider network (SPN) that offers or otherwise provides broadband services to consumers. In some instances, the base station radio devices may communicatively couple to the SPN via a backhaul network, such as fiber-optic, cables, and/or wireless technology, such as millimeter wave (mmWave) technology. However, regardless of the specific implementation, the communication between the base station radio devices and the SPN represents a high-speed communication path for providing broadband services.

The base station radio devices function to provide broadband services to the CPEs (and ultimately the premise) by wirelessly communicating with the CPEs. To wirelessly communicate with one another, the base station radio devices and the CPEs may include modems, antenna(s), an array of antenna(s), transceiver systems, antenna feed networks, and so forth. In some instances, the antenna(s) of the base station radio devices and/or the antenna(s) of the CPEs may include a plurality of modems and/or antennas for communicating over a range of frequencies (e.g., mid frequencies, high frequencies, etc.). The antenna(s) of the base station radio device(s) and/or the CPEs may include antennas for any disparate number of communication technologies (e.g., 4G LTE, 5G, etc.). In some instances, the CPE may include modular components for interchanging modems, antenna(s), and so forth depending on the communication technologies utilized for delivering broadband services.

The CPEs are installed at the premise of the consumer (e.g., home and/or place of business) and may represent a fixed wireless device. In some instances, the CPEs may be installed on an exterior side of the premise at a demarcation point in which services (e.g., power, phone, television, etc.) are provided into the premise. In some instances, the CPE may be installed within an electric meter panel and coupled to the electric meter and the electrical wiring of the premise. For example, the CPE may include a housing that fits within an existing electric meter panel. When installed, the CPE may be interposed between the electric meter panel and the electric meter. This coupling provides power to the CPE, transfers power to the electric meter for metering, and connects the CPE with (or to) the electrical wiring of the premise.

The CPE further includes a WAN mesh component that wirelessly communicates with one or more WANs, separate from the wireless communication with the base station radio device. For example, the WAN mesh component may mesh multiple WANs, such as cellular (e.g., 3G, 4G, 4G LTE, 5G, etc.), Wi-Fi (e.g., 802.11), and so forth. These multiple WANs may be provided by other premises (e.g., home, store, etc.), devices, routes, and the like that are adjacent to the premise. A consumer, for example, may subscribe to the other WANs that are available at the premise. As an example, the WAN mesh component may mesh a 5G WAN with a 4G LTE WAN as a way to increase throughput of broadband services provided to the premise. The WAN mesh component is configured to mesh multiple WANs into a single network that is wirelessly provided to the premise. Antenna(s), array(s), transceiver(s), and the like may receive signals from the additional WANs.

In some instances, the WAN mesh component is configured to mesh LAN (e.g.802.11). However, in some instances, the WAN mesh component may combine or aggregate LAN signals received over disparate spectrums, frequencies, or communication protocols (as noted above). Additionally, the WAN mesh component may mesh with LAN Wi-Fi (802.11) and with BPL (G.hn/1901 Homeplug)) to cover full range of broadband services.

The CPE is configured to transmit two signals, such as one wired signal and one wireless signal, into the premise for providing the broadband services to the premise. For example, a first signal may represent a conductive signal that is transmitted over the electrical wiring of the premise. The conductive signal is associated with the broadband services received via the base station radio device. In this sense, the CPE transmits a first portion of the broadband services over the electrical wiring of the premise, and through communicatively coupling with the electrical wiring at the utility meter. A second signal may represent a radio frequency (RF) signal that is wirelessly transmitted into the premise, and the second signal provides a second portion of the broadband services to the premise. For example, after the WAN mesh component meshes multiple LANs, the CPE may wirelessly transmit the RF signal into the premise.

Both the conductive signal and the RF signal are provided as a way to increase access and throughput of the broadband services into the premise. For example, the conductive signal may provide a first broadband services speed, such as 100 megabytes per second (mbps), while the RF signal may provide a second broadband services speed, such as 25 mbps. Noted above, this 25 mbps may be provided across one or more WANs that are meshed together and combined in the LAN. By transmitting both of these signals into the premise, the broadband services combined into the local area network may be upwards of 125 mbps.

The signals are transmitted by the CPE to a router located within an interior of the premise. The router receives the conductive signal and the RF signal and aggregates the signals to provide a single network within the premise. For example, the router may receive the conductive signal from the CPE and the RF signal from the CPE for providing broadband services to the premise. The broadband services received via the conductive signal and the RF signal are aggregated at the router and subsequently, the router broadcasts a single network (e.g., Wi-Fi mesh) to the premise. In this sense, despite the multiple networks to which the CPE is connected, the router broadcasts a single network to which consumer devices within the premise are able to connect.

In some instances, the router may be plugged into an outlet within the interior of the premise and located proximate to the CPE to reduce dissipation and/or noise via BPL, as well as the RF signals transmitted by the CPE dissipating (e.g., via building penetration). The router and the CPE may be paired with one another as part of an out of box experience (OOBE) for providing broadband services to the premise. Therein, the router may broadcast broadband services within an interior of the premise.

The CPE includes one or more interfaces for communicating with the base station radio device, the WANs, and the router. For example, the CPE may include a BPL interface, a modem module coupled to antenna(s), and a transceiver. The BPL interface and the modem module may respectively transmit the conductive signal and the RF signal to the router. In some instances, the BPL interface and the modem module (and/or the antenna(s)) may be components of a system on a chip (SoC) of the CPE. As the antenna(s) of the CPE receives the broadband services from the base station radio device(s), the BPL interface communicates the broadband services to a corresponding BPL interface of the router. Such transmission may also involve a use of the modem module. Noted above, the BPL interface is configured to transmit the broadband services over the electrical wiring of the premise to the router. Additionally, the antenna(s) of the CPE receives the broadband services from the WAN, the WAN mesh component meshes the WANs, and a transceiver may transmit signals to the router. Such transmission may also involve a use of a modem module, whether the same modem module or a different modem module as used by the BPL interface.

The router, which is located within the interior of the premise, may include a BPL interface for receiving the broadband services from the CPE. The BPL interface of the CPE and the BPL interface of the router therefore allows for the CPE and the router to communicate over the electrical wiring of the premise. The router also includes a transceiver for receiving the RF signals transmitted by the transceiver of the CPE. For example, the transceiver of the CPE may represent an 802.11 mesh embedded device that communicates from the WAN outside of the premise to the router located inside the premise. The transceiver of the router may represent an 802.11 mesh embedded device that receives signals from the transceiver of the CPE. The two 802.11 devices form a single mesh, using 2.4 Ghz or 5 Ghz, for example, to penetrate the premise.

A local area network (LAN) aggregator of the router aggregates the conductive signal and the RF signal as received from the CPE. By aggregating the conductive signal and the RF signal, the router is able to provide broadband services to the premise at an increased rate (e.g., speed). For example, the router further includes a wireless modem and antenna(s) for distributing broadband services to the premise, or the consumer device(s), within the premise. The antenna(s) of the router may include a Wi-Fi module for supplying the premise with Wi-Fi (e.g., 2.4 GHz Wi-Fi, 5 GHz Wi-Fi, 6 GHz, etc.). The antenna(s) may also be modular or interchangeable to provide additional Wi-Fi frequency bands to the premise. In some instances, the router may broadcast the broadband services via wireless and/or wired technologies (e.g., Ethernet, coaxial cable, USB, twisted pair, plastic fiber, etc.). In some instances, the antenna(s), BPL interface, and/or modem of the router may be components of a SoC of the router.

In some instances, wirelessly coupling the base station radio device and the CPE may avoid conventional problems associated with providing broadband services to individual premises. For example, costs, time, and inconveniences, sometimes referred as the last mile problem, are often limiting factors in providing broadband services. Compared to conventional techniques that physically connect premises to the SPN, using wireless communication between the base station radio device and the CPE, as well as BPL technology, may reduce these challenges. For example, consumers may no longer be expected to be home while broadband services is set up. In this manner, coupling the CPEs to the electrical wiring of the premise (i.e., the electric meter panel and the electric meter) also addresses challenges associated with building penetration. Even more so, the CPE is able to take advantage of throughput provide by adjacent or nearby WANs as a way to increase access to broadband services.

The present disclosure provides an overall understanding of the principles of the structure, function, device, and system disclosed herein. One or more examples of the present disclosure are illustrated in the accompanying drawings. Those of ordinary skill in the art will understand and appreciate that the devices, the systems, and/or the methods specifically described herein and illustrated in the accompanying drawings are non-limiting embodiments. The features illustrated or described in connection with one embodiment, or instance, may be combined with the features of other embodiments or instances. Such modifications and variations are intended to be included within the scope of the disclosure and appended claims.

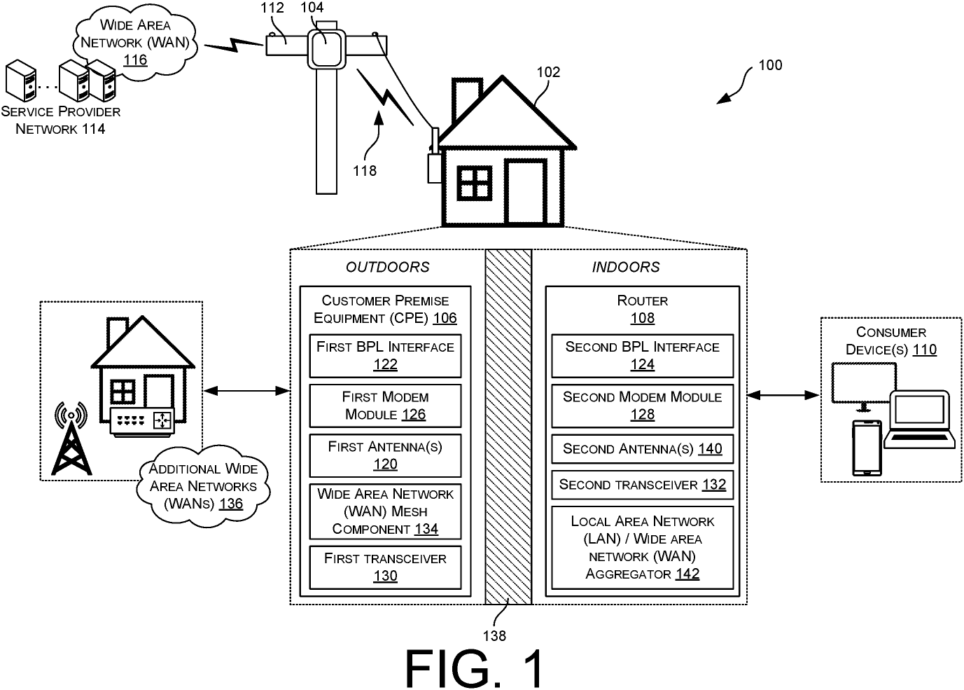

FIG. 1 illustrates an example environment 100 for providing broadband services (e.g., internet) to a premise 102 (e.g., building, house, multi-dwelling complex, etc.) by aggregating multiple diverse technologies.

In some instances, the environment 100 includes one or more base station radio device(s) 104, one or more customer premise equipment (CPE) 106, one or more router(s) 108, and/or one or more consumer device(s) 110. The base station radio device(s) 104 is shown coupled to structures 112 (e.g., utility pole structures) for being disposed above the ground, or overhead. In some instances, the base station radio device(s) 104 may be configured to mount to the structures 112 to vertically dispose the base station radio device(s) 104 above the ground. For example, the base station radio device(s) 104 may be disposed on a side of a building, a light pole, stop lights, telephone poles, and so forth.

In some instances, the base station radio device(s) 104 may be disposed on the structures 112 for communicatively coupling to a service provider network (SPN) 114, or other internet service provider (ISP). The SPN 114 may be accessed, for example, via a wide area network (WAN) 116. The WAN 116 connects computers, or other devices, that span a wide geographical area. As explained herein, the WAN 116 provides access to the internet services, available by the SPN 114, to the consumer device(s) 110 located within the premise 102.

In some instances, a backhaul may couple the base station radio device(s) 104 to the SPN 114, over the WAN 116. The backhaul may, in some instances, include cables (e.g., fiber-optic cables) that span between the structures 112, computers, switches, hubs, and/or devices on the WAN 116, whether wired and/or wirelessly, and which ultimately route to the SPN 114 for providing broadband services to the premise 102. In some instances, the backhaul may route to a middle-mile location with broadband services (e.g., hospital, police station, etc.) before routing to the SPN 114. In some instances, additionally or alternatively, the base station radio device(s) 104 may communicate with the SPN 114 via wireless technologies (e.g., mmWave). However, the backhaul may be routed differently than shown for communicating with the SPN 114. For example, rather than the backhaul being disposed on the structures 112, the backhaul (or portions thereof) may be buried and the base station radio device(s) 104 may couple to the backhaul. As such, it is to be understood that the SPN 114 provides access to the WAN 116 to offer the broadband services.

Regardless of the specific implementation, the base station radio device(s) 104 may be connected to the SPN 114, over the WAN 116, for accessing broadband services provided by the SPN 114. Disposing the base station radio device(s) 104 on the structures 112 utilizes an existing network of vertical structures. Furthermore, discussed herein, disposing the base station radio device(s) 104 on the structures 112, or other vertical structures, may provide an unobstructed transmission path (or reduced unobstructed path) between the base station radio device(s) 104 and the CPEs 106, vice versa. Additionally, noted above, in communities that lack the structures 112, the base station radio device(s) 104 may be disposed on other vertical structures, such as light poles.

In some instances, a network of the base station radio device(s) 104 may function to provide broadband services to one or more premises. For example, a first base station radio device may be disposed on a first structure to provide broadband services to one or more first premises, while a second base station radio device may be disposed on a second structure to provide broadband services to one or more second premises. In some instances, the one or more first premises may be the same as, or include some of, the one or more second premises. For example, referring to FIG. 1, the base station radio device 104 may provide broadband services to multiple premises, including the premise 102. However, it is to be understood that more than two base station radio device(s) 104 may be included and any number of base station radio device(s) 104 may installed for providing broadband services to a geographical region. For example, within densely populated areas, a larger number of base station radio device(s) 104 may be installed per block, radius, mile, etc. as compared to less densely populated areas. In this sense, the system may be scaled as needed depending on demand, usage, and/or throughput requirements.

The base station radio device(s) 104 communicate with nearby CPEs, such as the CPE 106, installed at the premise 102. In some instances, the CPE 106 may be configured to attach as a meter collar within existing electric meters (or panels), which may be a smart meter of the premise 102, on an exterior of the premise 102. For example, the meter collar may include a power module configured to supply power to the CPE 106 and which couples to the electrical wiring of the premise 102 (e.g., as received from power lines spanning between the structures 112). Alternatively, the CPE 106 may attach to the premise 102 at any demarcation point between a utility service and the premise 102 (e.g., electrical panel). As such, coupling the CPE 106 at or within the meter collar of the utility service panel couples the CPE 106 to electrical wiring of the premise 102.

The base station radio device 104 may wirelessly communicate with the CPE 106 to provide broadband services offered by the SPN 114. In some instances, the base station radio device 104 and the CPE 106 communicate over a communication channel 118, which may support any dynamically shared spectrum (DSS) (e.g. between 3100 MHz and 4200 MHz). In some instances, the communication channel 118 may support the Citizens Broadcast Radio Spectrum (CBRS) between 3550 MHz and 3700 MHz. In some instances, the communication channel 118 may include any low-band, mid-band and/or high-band frequencies, regardless of the DSS. However, it is to be understood that the communication channel 118 may support any range of frequencies for providing broadband services to the premise 102.

The CPE 106 includes first antenna(s) 120 (or a multi-antenna array) for communicating, via the communication channel 118, with the base station radio device 104 and via an antenna of the base station radio device 104 (not shown in FIG. 1.). Such communication channel 118 may be over 5G. In some instances, depending on the range of frequencies (or spectrum) at which the base station radio device 104 and the CPE 106 are configured to communicate, the CPE 106 may be configured accordingly. For example, the first antenna(s) 120 may be interchangeable to accommodate for the spectrum, or range of frequencies, at which the base station radio device 104 and the CPE 106 communicate. In such instances, components of the CPE 106 may be modular or configurable to change antennas, modems, interfaces, and so forth. Multiple antennas, or antenna housings, may be configured to attach to the CPE 106. Such configuration may make the CPE 106 modifiable to accommodate new technologies and communication protocols.

As an example, the CPE 106 may include, or the first antenna(s) 120 of the CPE 106 may represent, a multi-antenna array having antennas (e.g., two, three, four, etc.). In some instances, the first antenna(s) 120 may be arranged with different polarizations. The first antenna(s) 120 may include sub-arrays having multiple patches or elements (e.g., two). In some instances, each sub-array of the multi-antenna array may include two or more orthogonally polarized elements and each element of the sub-array may include a dedicated antenna feed port. By selecting specific polarizations, and determining the phase and or amplitude of the antenna feeds, the first antenna(s) 120 may have a radiation pattern with a predetermined variable polarization. Additional details of polarization for increasing diversity is described in, for example, U.S. Pat. Application No. 17/202,526, entitled “Modular Customer premise equipment for Providing Broadband Internet,” filed Mar. 3, 2021, the entirety of which is herein incorporated by reference.

The CPE 106 includes one or more interface(s) for communicatively coupling with the router 108 and providing the broadband services to the consumer device(s) 110. In some instances, the interfaces communicatively couple the CPE 106 and the router 108 over the electrical wiring of the premise for providing broadband services to the consumer device(s) 110 within the premise 102. (e.g., personal computer, laptop, television, printer, audio/video receiver, audio equipment, video equipment, mobile devices, tablets, etc.). For example, the CPE 106 is shown including a first BPL interface 122 for communicating with a second BPL interface 124 of the router 108. The BPL interfaces allow the CPE 106 and the router 108 to communicate over the electrical wiring of the premise 102 for communicatively coupling the consumer device(s) 110 to the SPN 114.

For example, the first BPL interface 122 may communicatively couple to the first antenna(s) 120 for receiving broadband services, signals, or data via the base station radio device(s) 104. The first BPL interface 122 then transmits the broadband services, signals, or data to the second BPL interface 124 of the router 108. In some instances, the first BPL interface 122 communicatively couples to a first modem module 126 for communicating with the second BPL interface 124. Correspondingly, the router 108 may also include a second modem module 128 that communicatively couples to the second BPL interface 124.

In addition to the BPL interfaces, the CPE 106 may include a first transceiver 130 for communicating with a second transceiver 132 of the router 108. The first transceiver 130 and the second transceiver 132 act to wirelessly receive and transmit broadband services, signals, or data between the CPE 106 and the router 108. In some instances, the CPE 106 may transmit data to the router 108 over a WAN/WAN using unlicensed spectrum (e.g. 5 Ghz/2.4 Ghz mesh) or aggregating multiple spectrums (e.g.2.5 Ghz and 3.55 Ghz mesh). Additionally, the CPE 106 may transmit the data via a WAN/LAN mesh using 5Ghz/2.4Ghz/BPL mesh created from the CPE 106. The first transceiver 130 may communicatively couple to the first antenna(s) 120 and/or the first modem module 126 for transmitting and receiving broadband services, signal, or data from the second transceiver 132. Here, too, the second transceiver 132 may communicatively couple to the second modem module 128 for transmitting and receiving broadband services, signals, or data. For example, the first transceiver 130 of the CPE 106 may represent an 802.11 mesh embedded device that communicates from the WAN outside of the premise 102 to the router 108 located inside the premise 102. The second transceiver 132 of the router 108 may represent an 802.11 mesh embedded device that receives signals from the first transceiver 130 of the CPE 106. The two 802.11 devices form a single mesh, using 2.4 Ghz or 5 Ghz, for example, to penetrate the premise 102.

The CPE 106 is shown including a wide area network (WAN) mesh component 134. The WAN mesh component 134 is configured to mesh multiple wide area networks (WANs) external to the premise 102 into a single mesh WAN that is provide to the premise 102. In some instances, the WAN mesh component 134 is configured to mesh 802.11 WANs. However, in some instances, the WAN mesh component 134 may combine or aggregate signals received over disparate spectrums, frequencies, or communication protocols. Additionally, the WAN mesh component 134 may mesh twisted pair with BPL (802.11AC) to cover full range of wireless internet. As such, other 802.11 standards may be implemented. Once combined, the CPE 106 may provide broadband services, signals, or data to the premise 102. Such broadband services, signals, or data may be in addition to the broadband services, signals, or data provided by BPL.

For example, the WAN mesh component 134 may mesh additional WANs 136 provided by other SPNs, ISPs, and so forth. For example, FIG. 1 illustrates that the additional WANs 136 may be provided from adjacent premises, cellular towers, and so forth. That is, in addition to the CPE 106 accessing the WAN 116 provided by the SPN 114, the CPE 106 may also have access the additional WANs 136. For example, consumers may subscribe to these additional WANs 136 as a way to increase throughput of broadband services, signal, or data at the premise 102.

The WAN mesh component 134 is configured to mesh the additional WANs 136 (e.g., one, two, three, four, etc.) into a single WAN that is provided to the premise 102. For example, the first antenna(s) 120 may receive signals from the additional WANs 136. The WAN mesh component 134 may aggregate these signals into a single WAN that is provided to the premise 102. Therein, the first transceiver 130 may transmit, using the first antenna(s) 120, for example, the wireless or RF signals to the router 108. In some instances, the first transceiver 130 is communicatively coupled to the first modem module 126 for providing the wireless signals to the router 108.

In this sense, a portion of the broadband services supplied to the premise 102 may come by way of the electrical wiring of the premise 102, through conductive signals provided by the first BPL interface 122, while another portion of the broadband services may come by way of wirelessly communication between the CPE 106 and the router 108, through RF signals provided by the first transceiver 130. To briefly illustrate, the first antenna(s) 120 may receive broadband data from the additional WANs 136. This broadband data, if received over multiple additional WANs 136, is meshed together via the WAN mesh component 134 into a single meshed WAN. Therein, the first transceiver 130 may transmit (using the first antenna(s) 120 and/or the first modem module 126), broadband services to the router 108. These broadband services, however, are wirelessly transmitted through a premise structure 138, to the second transceiver 132 (or using second antenna(s) 140 and/or the second modem module 128 of the router 108). Additionally, broadband data is received from the first antenna(s) 120 via the base station radio device(s) 104. Subsequently, this broadband data is communicated with the first BPL interface 122 and the first BPL interface 122, or the first modem module 126, then transmits the broadband data through the premise structure 138, via the electrical wiring of the premise 102, to the second BPL interface 124. As such, the CPE 106 transmits both conductive signals and RF signals to the router 108 as a way to increase throughput to the premise 102.

The router 108 includes a local area network (LAN) / wide area network (WAN) aggregator 142 that aggregates or bridges the broadband data received wirelessly as well as the broadband data received at the second BPL interface 124 and via the electrical wiring of the premise 102 (from the first BPL interface 122). The LAN /WAN aggregator 142 is configured to combine the broadband data received from the different communication technologies to provide the broadband services to the consumer device(s) 110. For example, the LAN/WAN aggregator 142 combines a signal received via the electrical wiring of the premise 102 (e.g., a conducted signal) with a signal wirelessly received. This aggregation forms a single mesh network (LAN) that is then broadcasted within the premise 102 to the consumer device(s) 110. For example, using the second antenna(s) 140, the router 108 broadcasts the broadband data to the consumer device(s) 110. The consumer device(s) 110 may have corresponding antenna(s) to communicate with the second antenna(s) 140 of the route. The router 108 may include a Wi-Fi module to supply Wi-Fi to the premise 102. The router 108, however, may be configured to provide Wi-Fi other than 2.4 GHz and 5.0 GHz (e.g., Near Field Communication (NFC)). Additionally, or alternatively, in some instances, the router 108 may broadcast the broadband services to the consumer device(s) 110 via wired technologies such as Ethernet, USB, coaxial, fiber optic, and the like. In such instances, the router 108 may include plug-ins for receiving the wired technologies.

In some instances, the router 108 may represent a wall plug-in or device that otherwise plugs into a power outlet within the premise 102. The router 108 may receive power, via the power outlet, and ultimately via the electrical wiring of the premise 102. As the CPE 106 couples to the electrical wiring of the premise 102, via coupling to the electric meter, the CPE 106 may communicate with the router 108 over the electrical wiring within the premise 102. For example, the meter collar may couple the CPE 106 with the neutral, earth ground wires and/or the line voltage wires that are fed into the premise 102 (or which feed into the breaker box of the premise 102). Once the router 108 is plugged in, the CPE 106 may communicate with the router 108 using the electrical wiring (e.g., wires). The BPL interfaces of the CPE 106 and the router 108, respectively, decipher, interpret, and communicate with one another for transmitting and receiving data. In some instances, the CPE 106 and the router 108 may be paired together as part of an installation process in order to provide the broadband services.

In some instances, the CPE 106 or the first antenna(s) 120 of the CPE 106 may be configured to beam-form for achieving optimum link properties with the base station radio device(s) 104 or the additional WANs 136 (or devices, systems, etc.). In some instances, the beam-forming may be achieved by using an antenna array or a multiple input multiple output (MIMO) antenna. Additionally, while one pathway of communication is described, it is to be understood that the router 108 may similarly communicate with the CPE 106 for transmitting data from the router 108 to the CPE 106, from the CPE 106 to the base station radio device 104, and/or from the CPE 106 to the additional WANs 136.

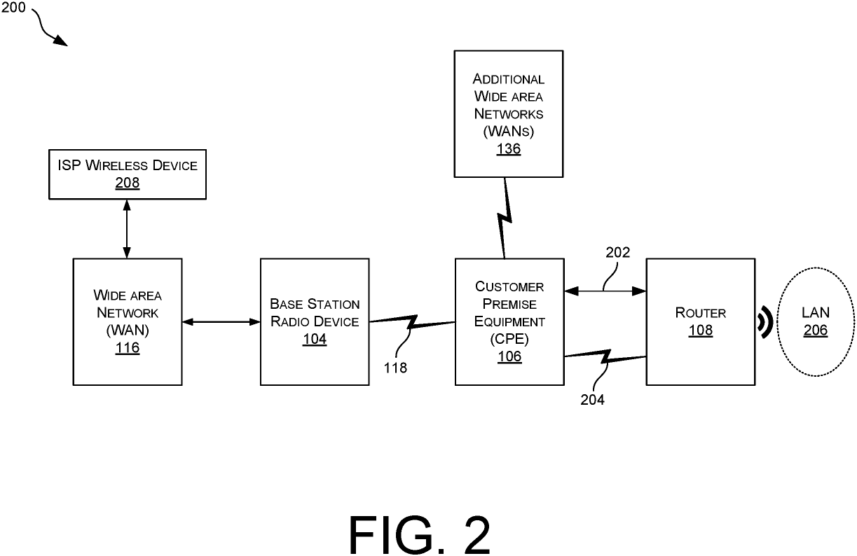

FIG. 2 illustrates an example diagram 200 for providing broadband services to the premise 102. As discussed above, the CPE 106 may be disposed on an exterior of the premise 102 while the router 108 is disposed on an interior of the premise 102. The CPE 106 communicatively couples to the router 108 via a wired or conductive signal 202 (e.g., through the first BPL interface 122 and the second BPL interface 124) and a wireless or RF signal 204 (e.g., through the first transceiver 130 and the second transceiver 132).

The CPE 106 is shown communicatively coupled to the base station radio device 104 via the communication channel 118 for communicatively coupling to the WAN 116. The communication channel 118 between the base station radio device 104 and the CPE 106 may represent a wireless signal or wireless communication pathway. Additionally, the CPE 106 communicatively couples to the additional WANs 136. Such communication may be also be wireless. That is, as noted above, the CPE 106 may wirelessly connect to the additional WANs 136, in addition to the WAN 116 provided by the SPN 114.

Further, as introduced above, the CPE 106 may aggregate the additional WANs for providing the RF signal 204 into the premise 102. For example, the CPE 106 may receive signals from the additional WANs, and mesh the signals from the additional WANs 136 into a single WAN that is provided to the premise 102. The WAN mesh component 134, for example, may aggregate a plurality of signals from the additional WANs 136. In some instances, the WAN mesh component 134 may correspond to, or the CPE 106 may include, a multi-WAN router (MWR). The WAN mesh component 134 may also aggregate signals from WAN received across a plurality of frequencies. For example, the CPE 106 may receive first broadband signals or data over a first frequency and second broadband signals or data over a second frequency, and combine (i.e., mesh) the first broadband signals or data with the second broadband signals or data before wirelessly transmitting the RF signal 204 to the router 108. This RF signal 204, noted above, is alternative from the conductive signal 202 provided from the CPE 106 to the router 108.

Inside the premise 102, in some instances, the router 108 aggregates the conductive signal 202 and the RF signal 204. For example, the LAN /WAN aggregator 142 of the router 108 may receive the conductive signal 202 and the RF signal 204 and combine the conductive signal 202 and the RF signal 204 to produce a signal network that is provided to the premise 102. This network, as shown in FIG. 2, may be a LAN 206 (e.g., Wi-Fi, 2.4 GHz, 5.0 GHz, NFC, etc.) to which the consumer device(s) 110 are able to couple.

In some instances, rather than wirelessly receiving broadband services via the base station radio device 104, the CPE 106 may wirelessly couple to an ISP wireless device 208, or wireless services. Additionally, although the CPE 106 is describe as meshing multiple wireless WAN, the CPE 106 may mesh other WAN provided by other communication technologies. For example, the additional WANs may come by way of coaxial cables, twisted pair cables, fibers, and so forth. In this sense, the CPE 106 may represent a hub that is utilized mesh the additional WANs 136, whether the additional WANs are wired or wireless, for providing the RF signal 204 into the premise 102.

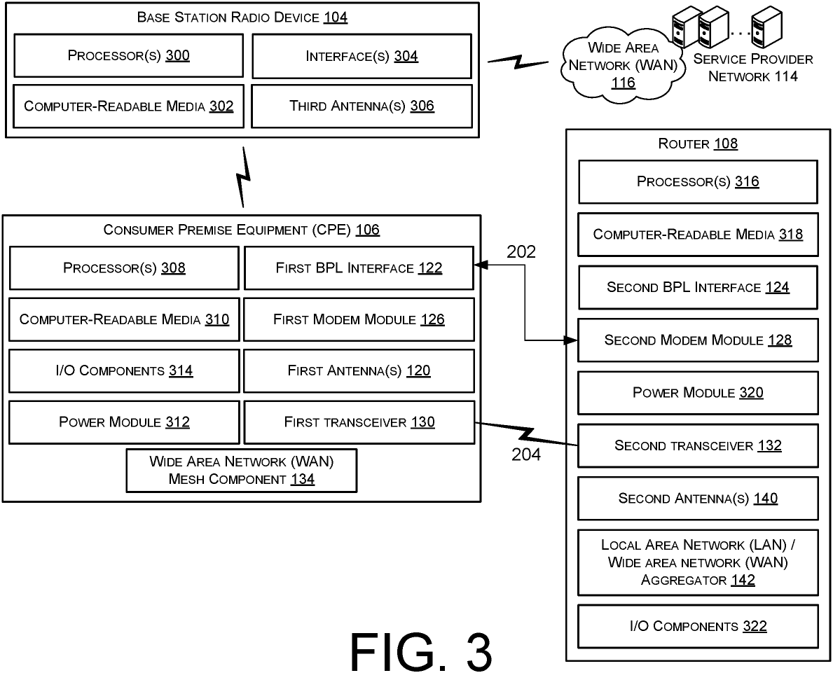

FIG. 3 illustrates example components of the base station radio device 104, the CPE 106, and the router 108. Discussed above, the base station radio device 104 may be in communication via wired technologies (e.g., a fiber-optic cable network) and/or wireless technologies (e.g., mmWave) with the SPN 114, or the WAN 116 provided by the SPN 114.

The base station radio device 104 may include one or more processor(s) 300, computer-readable media 302, interface(s) 304, and/or third antenna(s) 306. The processor(s) 300 may include a central processing unit (CPU), a graphics processing unit (GPU), both a CPU and a GPU, or other processing units or components. Additionally, each of the processor(s) 300 may possess its own local memory, which also may store program modules, program data, and/or one or more operating systems.

The processor(s) 300 may be coupled to the computer-readable media 302 and execute computer executable instructions stored in the computer-readable media 302. The processor(s) 300 may also couple modules and components of the base station radio device 104 to one another and may perform various functions including instructing and causing the modules and components of the base station radio device 104 to perform their associated functions. For example, the processor(s) 300 may cause components of the base station radio device 104 to transmit and receive broadband data from the SPN 114, as well as transmit and receive broadband data from the CPE 106. In some instances, the base station radio device 104 may additionally or alternatively include a WAN mesh component.

As the base station radio device 104 may communicatively couple to multiple CPEs 106 to provide broadband services, the base station radio device 104 may store, in the computer-readable media 302, indicators and/or identifying information of individual CPEs 106. Such information may be utilized for communicating (e.g., routing) with respective CPEs 106 at a respective premise 102. For example, a particular base station radio device 104 may provide broadband services to multiple premises. As the base station radio device 104 sends data to respective premises, or receives data from the respective premises, the base station radio device 104 may tag or otherwise mark this outgoing and incoming data. This marking may indicate which premise is the recipient and/or originator of the data. As such, the base station radio device 104 may transmit the data to the respective premises, or to the proper recipients.

The interface(s) 304 couple the base station radio device 104 to the SPN 114 (e.g., via the fiber-optic broadband network) for accessing broadband services. Additionally, the interface(s) 304 may couple the base station radio device 104 to the CPE 106. For example, the interface(s) 304 may be coupled to the processor(s) 300 and the third antenna(s) 306 for communicating with the CPE 106 (and/or a plurality of CPEs 106) to provide broadband services. In some instances, the interface(s) 304 may include modems, modules, or other components for wirelessly coupling with the CPE 106. For example, the interface(s) 300 may include a DSS modem module, a CBRS modem module, C-band modem module, a WWAN modem module, and/or any other modem/module for communicating, via the communication channel 118, with the CPE 106 (e.g., mid frequencies, high frequencies, etc.). The base station radio device 104 may therefore include a plurality of interface(s) 300 for communicating with corresponding interfaces (e.g., the first modem module 126) of the CPE 106.

In some instances, the interface(s) 300 may include interfaces for interacting with WANs, cellular networks, and so forth. The third antenna(s) 306 may include an array of antennas for otherwise transmitting data to, and receiving data from, the CPE 106. In some instances, the third antenna(s) 306 may beam-form for achieving optimum link properties with the CPE 106 and/or the SPN 114. The base station radio device 104 may include additional interface(s) for communicating with other base station radio device(s) 104 (and ultimately the SPN 114) using wired and/or wireless technologies. Additionally, the third antenna(s) 306 may be capable of receiving signals with varying polarizations from the CPE 106 (e.g., vertical, horizontal, elliptical, etc.).

In some instances, the base station radio device 104 may include input/output (I/O) components coupled to the processor(s) 300. The I/O components may be configured to communicate with a computing device, such as a computing device loaded with appropriate applications for programming or checking the status of the base station radio device 104. For example, the computing device may be operated by a utility service or company providing the broadband services to the premise 102, and which is used for monitoring and/or troubleshooting issues experienced by the base station radio device 104 and/or the CPE 106. The I/O components may also provide other information from the premise 102, such as usage data, data generated by appliances within the premise 102 (e.g., IoT), for use in energy savings, system management, and/or load to service determination.

The base station radio device 104 communicatively couples to the CPE 106 via the communication channel 118. As shown, the CPE 106 may include one or more processor(s) 308, computer-readable media 310, the first antenna(s) 120, the first BPL interface 122, and the first modem module 126, as discussed above with regard to FIG. 1. In some instances, the processor(s) 308 may include a CPU and/or a GPU. Additionally, the processor(s) 308 may possess its own local memory, which also may store program modules, program data, and/or one or more operating systems. The processor(s) 308 may be coupled to the computer-readable media 310 and execute computer executable instructions stored in the computer-readable media 310.

The processor(s) 308 may be also coupled modules and components of the CPE 106 and may perform various functions including instructing and causing the modules and components of the CPE 106 to perform their associated functions. For example, the processor(s) 308 may cause components of the CPE 106 to send and receive broadband data to and from the base station radio device 104, and to send and receive broadband data to and from the router 108. For example, as the first antenna(s) 120 receive broadband data from the base station radio device 104, via the communication channel 118, the processor(s) 308 may cause the broadband data to be sent to the router 108 via the first BPL interface 122. Such transmission may occur via the conductive signal 202, between the first BPL interface 122 and the second BPL interface 124. For example, the first BPL interface 122 of the CPE 106 is shown communicating with the second BPL interface 124 of the router 108. A communication channel exists between the first BPL interface 122 and the second BPL interface 124, representative of the conductive signal 202. Noted above, this communication channel may represent a communication channel over the electrical wiring of the premise 102, whereby the broadband data is transmitted over wires or other cables within the premise 102.

In some instances, the first BPL interface 122 communicatively couples to the first modem module 126 and the second BPL interface 124 communicatively couples to the second modem module 128. The first modem module 126 may include a corresponding module for communicating with the interface(s) 304 of the base station radio device 104 (e.g., DSS, CBRS, G.hn, WWAN, C-band, etc.). As the first modem module 126 receives broadband data, via the first antenna(s) 120, the first modem module 126 may interpret the broadband data. The first BPL interface 122 then transmits the broadband data to the second BPL interface 124, whereby the second modem module 128 may interpret the broadband data.

Additionally, as the first antenna(s) 120 receive broadband data from the additional WANs 136, the WAN mesh component 134 may mesh the additional WANs 136, and the processor(s) 308 may cause additional broadband data to be sent to the router 108. For example, the first transceiver 130 may transmit the broadband data to the second transceiver 132 of the router 108. Such transmission may occur via the RF signal 204, between the first transceiver 130 and the second transceiver 132. A communication channel exists between the first transceiver 130 and the second transceiver 132, representative of the RF signal 204, and the CPE 106 and the router 108 may wirelessly communicate with one another.

In some instances, the first transceiver 130 communicatively couples to the first modem module 126 and the second transceiver 132 communicatively couples to the second modem module 128. As the first modem module 126 receives broadband data, via the first antenna(s) 120 and the additional WANs 136, the first modem module 126 may interpret the broadband data. The first transceiver 130 then transmits the broadband data to the second transceiver 132, whereby the second modem module 128 may interpret the broadband data. The processor(s) 308 may therefore route broadband data from the first antenna(s) 120 to interfaces of the CPE 106, and vice versa, for communicatively coupling with the router 108

As the router 108 receives the broadband data from the CPE 106, the router 108 may broadcast the broadband data throughout the premise 102. For example, the LAN /WAN aggregator 142 may aggregate the broadband data received via the conductive signal 202 and the broadband data receive via the RF signal 204. The LAN /WAN aggregator 142 may communicatively couple to the second modem module 128 to broadcast the broadband data to the consumer device(s) 110 via the second antenna(s) 140 as broadband internet, for example. In some instances, the second modem module 128 may represent a 2.4 GHz and/or 5.0 GHz Wi-Fi module communicatively coupled to the second BPL interface 124, the second transceiver 132, the LAN /WAN aggregator 142 to broadcast the broadband data, via the second antenna(s) 140, to the consumer device(s) 110.

The second modem module 128 may receive data from the consumer device(s) 110 (via the second antenna(s) 140). The second BPL interface 124 transmits the data to the first BPL interface 122 and the first modem module 126 broadcasts this data to the base station radio device 104 via the first antenna(s) 120. Additionally, or alternatively, the second transceiver may transmit the data to the first transceiver 130 and the first modem module 126 broadcasts this data to the additional WANs 136 via the first antenna(s) 120.

Although the first BPL interface 122, the first modem module 126, and the first transceiver 130 are shown as separate components, in some instances, the first BPL interface 122, the first modem module 126, and/or the first transceiver 130 may be integrated as a single component. In some instances, the first BPL interface 122, the first modem module 126, and/or the first transceiver 130 may be components of a SoC. Noted above, the first modem module 126 may also be modular and interchangeable depending on the frequencies which the first modem module 126 communicates with the base station radio device 104 and/or the additional WANs 136. Additionally, or alternatively, the second BPL interface 124, the second modem module 128, and/or the second transceiver 132 may be integrated as a single component. In some instances, the second BPL interface 124, the second modem module 128, and/or the second transceiver 132 may be components of a SoC. The second modem module 128 may also be modular and interchangeable depending on the Wi-Fi or network provided to the premise 102.

The CPE 106 includes a power module 312 coupled to the processor(s) 308. The power module 312 may be coupled to the electric meter of the premise 102 to supply electrical power from the electric meter to some or all components and modules of the CPE 106. The CPE 106, or a housing of the CPE 106 may be configured to attach as a meter collar to the electric meter. Coupling the CPE 106 to the utility meter in this manner also communicatively couples the first BPL interface 122 with the second BPL interface 124 via the electrical wiring of the premise 102. In this sense, the power module 312 may tap into the electrical wiring of the premise 102 for sending broadband data through the wiring of the premise 102, for delivery to the router 108. Using this form of communication allows broadband services to penetrate the premise 102 using existing wiring networks and alleviates the building penetration problem. Examples of coupling the CPE 106 to electric meter are discussed in, for example, U.S. Pat. Application No. 17/202,526, the entirety of which is herein incorporated by reference.

The CPE 106 may additionally include input/output (I/O) components 314 coupled to the processor(s) 308. The I/O interface components 314 may be configured to communicate with a programming device, such as a computing device of the utility service, or other device loaded with appropriate applications for programming or checking the status of the CPE 106 (or the broadband services). This communication may provide for testing, system upgrades, reboots, and so forth. The communication may also include data from an IoT within the premise 102 for use in load to service determination, energy savings, system usage, and so forth. In such instances, a user interface (UI) may be provided for interfacing with the CPE 106. In some instances, the I/O components 314 may comprise a connector, such as a telco connector, a USB connector, a RJ45 connector, and the like, and/or an RF communication module such as a NFC, Bluetooth communication, or Wi-Fi communication module for such communication.

The router 108 may include one or more processor(s) 316, computer-readable media 318, and the second BPL interface 124, the second modem module 128, and the LAN /WAN aggregator 142 as discussed above with regard to FIG. 1. In some instances, the processor(s) 316 may include a CPU and/or a GPU. Additionally, the processor(s) 316 may possess its own local memory, which also may store program modules, program data, and/or one or more operating systems. The processor(s) 316 may be coupled to the computer-readable media 318 and execute computer executable instructions stored in the computer-readable media 318. The processor(s) 316 also be coupled to modules and components of the router 108 and may perform various functions including instructing and causing the modules and components of the router 108 to perform their associated functions.

The router 108 includes a power module 320 coupled to the processor(s) 316. The power module 320 may be coupled to a power supply of the premise 102 (e.g., the electrical wiring) and receive electrical power to power components and modules of the router 108. Coupling the router 108 to the electrical wiring in this manner couples the second BPL interface 124 with the first BPL interface 122 via electrical wiring of the premise 102.

In some instances, the router 108 may include input/output (I/O) components 322 coupled to the processor(s) 316. The I/O components 322 may be configured to communicate with a computing device, such as a computing device loaded with appropriate applications for programming or checking the status of the router 108. For example, the computing device may be operated by a utility service providing the broadband internet to the premise 102, and which is used for monitoring and/or troubleshooting issues experienced by the base station radio device 104 and/or the CPE 106. Discussed above, the router 108 includes the second antenna(s) 140 for broadcasting the broadband services within the premise 102. Additionally, or alternatively, the router 108 may include plug-ins (e.g., Ethernet) for coupling to the consumer device(s) 110.

As used herein, a processor, such as the processor(s) 300, 308, and/or 316 may include multiple processors and/or a processor having multiple cores. Further, the processor(s) may comprise one or more cores of different types. For example, the processor(s) may include application processor units, graphic processing units, and so forth. In one implementation, the processor(s) may comprise a microcontroller and/or a microprocessor. The processor(s) may include a graphics processing unit (GPU), a microprocessor, a digital signal processor or other processing units or components known in the art. Alternatively, or in addition, the functionally described herein can be performed, at least in part, by one or more hardware logic components. For example, and without limitation, illustrative types of hardware logic components that may be used include field-programmable gate arrays (FPGAs), application-specific integrated circuits (ASICs), application-specific standard products (ASSPs), system-on-a-chip systems (SOCs), complex programmable logic devices (CPLDs), etc. Additionally, each of the processor(s) may possess its own local memory, which also may store program components, program data, and/or one or more operating systems.

Computer-readable media, such as the computer-readable media 302, 310, and/or 318 may include volatile and nonvolatile memory, removable and non-removable media implemented in any method or technology for storage of information, such as computer-readable instructions, data structures, program component, or other data. Such memory may include, but is not limited to, RAM, ROM, EEPROM, flash memory or other memory technology (e.g., embedded Multi-Media Controller (eMMC), SPI NOR), CD-ROM, digital versatile disks (DVD) or other optical storage, magnetic cassettes, magnetic tape, magnetic disk storage or other magnetic storage devices, RAID storage systems, DDR-SDRAM or any other medium which can be used to store the desired information and which can be accessed by a computing device. The memory may be implemented as computer-readable storage media (“CRSM”), which may be any available physical media accessible by the processor(s) to execute instructions stored on the memory. In one basic implementation, CRSM may include random access memory (“RAM”) and Flash memory. In other implementations, CRSM may include, but is not limited to, read-only memory (“ROM”), electrically erasable programmable read-only memory (“EEPROM”), or any other tangible medium which can be used to store the desired information and which can be accessed by the processor(s).

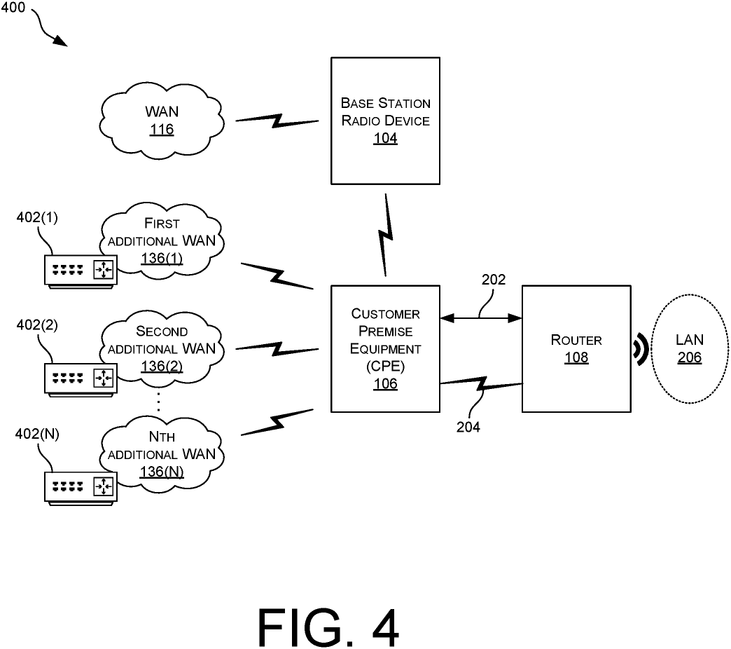

FIG. 4 illustrates an example diagram 400 for meshing multiple WANs, such as the additional WANs 136, using the CPE 106, and subsequently providing the RF signal 204 to the router 108. As shown, the base station radio device 104 provides the CPE 106 with access to the WAN 116. Additionally, the CPE 106 has access to a first additional WAN 136(1), a second additional WAN 136(2), up to an nth additional WAN 136(N). These additional WANs 136(1)-(N) may be provided by devices, computers, servers, switches, and so forth in surrounding buildings, residences, and so forth. For example, the first additional WAN 136(1) may be provided by a first device 402(1), the second additional WAN 136(2) may be provided by a second device 402(2), and the nth additional WAN 136(N) may be provided by a nth device 402(N). The devices 402(1)-(N) may be routers, modems, switches, and the like.

The additional WANs 136(1)-(N) may be within range of the CPE 106, and the CPE 106 may take advantage of the additional WANs 136(1)-(N) to provide an increased throughput to the premise 102. In some instances, the additional WANs 136(1)-(N) may be 802.11. However, the additional WANs 136(1)-(N) may be any 802.11 protocol (e.g., 802.11ac). The CPE 106 is configured to mesh the additional WANs 136(1)-(N) for providing the RF signal 204 to the premise 102. For example, using the WAN mesh component 134, the CPE 106 may mesh wireless, infrared, or RF signals associated with the additional WANs 136(1)-(N). Therein, the CPE 106 transmits the RF signal 204 to the router 108, which represents a culmination of the additional WANs 136(1)-(N). The CPE 106 also transmits the conductive signal 202 to the router 108, which represents a portion of the broadband services received through the electrical wiring of the premise 102, and via the base station radio device 104. Therein, the router 108, using the LAN /WAN aggregator 142, for example, aggregates the conductive signal 202 and the RF signal 204 to broadcast the LAN 206.

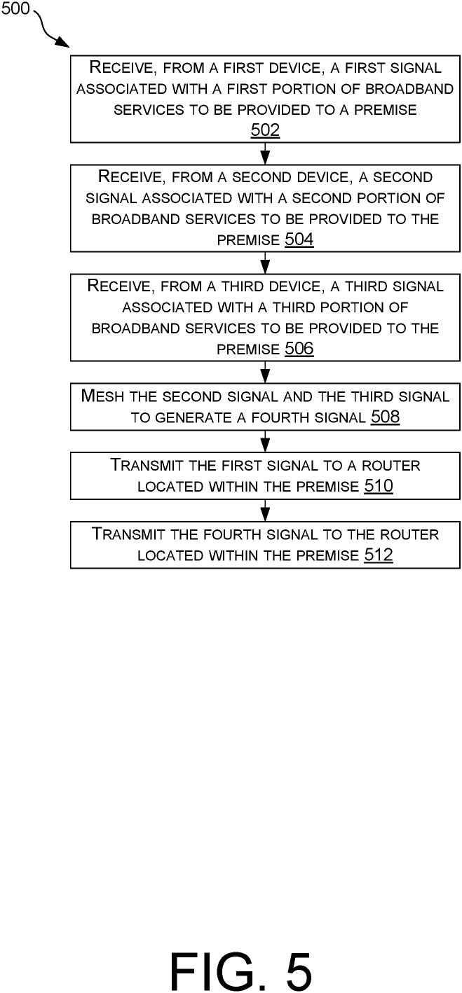

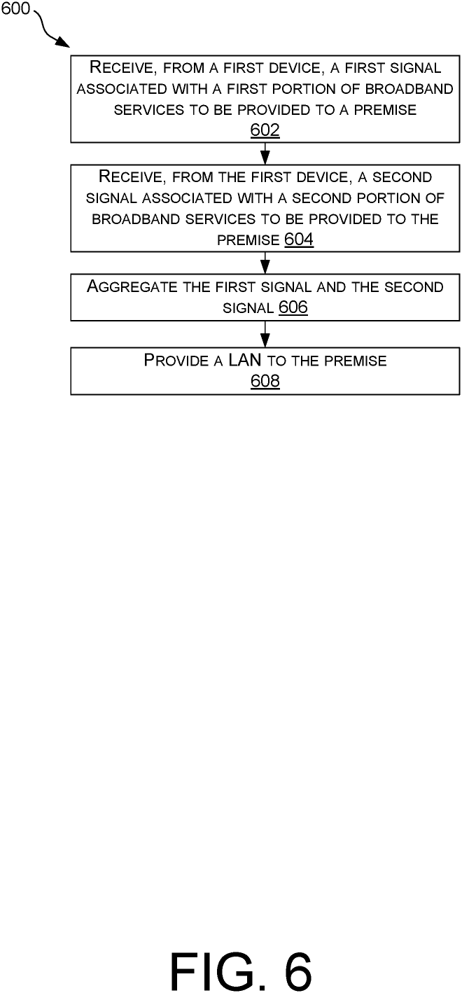

FIGS. 5 and 6 illustrate various processes related to increasing a throughput of broadband services to a premise. The processes described herein are illustrated as collections of blocks in logical flow diagrams, which represent a sequence of operations, some or all of which may be implemented in hardware, software, or a combination thereof. In the context of software, the blocks may represent computer-executable instructions stored on one or more computer-readable media that, when executed by one or more processors, program the processors to perform the recited operations. Generally, computer-executable instructions include routines, programs, objects, components, data structures and the like that perform particular functions or implement particular data types. The order in which the blocks are described should not be construed as a limitation, unless specifically noted. Any number of the described blocks may be combined in any order and/or in parallel to implement the process, or alternative processes, and not all of the blocks need be executed. For discussion purposes, the processes are described with reference to the environments, architectures and systems described in the examples herein, such as, for example those described with respect to FIGS. 1-4, although the processes may be implemented in a wide variety of other environments, architectures and systems.

FIG. 5 illustrates an example process 500 for transmitting signals to a premise, for providing the premise with broadband services.

At 502, the process 500 may include receiving, from a first device, a first signal associated with a first portion of broadband services to be provided to a premise. For example, the CPE 106 may receive the first signal from the base station radio device 104. The base station radio device 104 may wirelessly receive the first signal from the base station radio device 104. Ultimately, the base station radio device communicatively couples to the WAN 116 provided by the SPN 114.

At 504, the process 500 may include receiving, from a second device, a second signal associated with a second portion of broadband services to be provided to the premise. For example, the CPE 106 may receive the second signal from a second device (e.g., switch, router, etc.) that provides a WAN. In some instances, the second signal may be associated with a 802.11 WAN, however, other internet protocols may be used.

At 506, the process 500 may include receiving, from a third device, a third signal associated with a third portion of broadband services to be provided to the premise. For example, the CPE 106 may receive the third signal from a third device (e.g., switch, router, etc.) that provides a WAN. In some instances, the third signal may be associated with a 802.11 WAN, however, other internet protocols may be used.

At 508, the process 500 may include meshing the second signal and the third signal to generate a fourth signal. For example, the WAN mesh component 134 of the CPE 106 may mesh the second signal and the third signal into a single signal that is provided to the premise 102. In this manner, the CPE 106 is configured to mesh (e.g., aggregate) multiple wireless signal received across different networks, so as to provide a single signal to the premise 102.

At 510, the process 500 may include transmitting the first signal to a router located within the premise. For example, the CPE 106 (using the first BPL interface 122, the first antenna(s) 120, the first modem module 126, etc.) may transmit the first signal to the router 108. The first signal is transmitted through the electrical wiring of the premise 102. That is, as the CPE 106 connects to the electrical wiring of the premise 102, the first signal may be transmitted over the electrical wiring of the premise 102. The first signal may therefore represent a conductive signal that is transmitted to the router 108 (e.g., the conductive signal 202).

At 512, the process 500 may include transmitting the fourth signal to the router located within the premise. For example, the CPE 106 may transmit the fourth signal to the router 108. The fourth signal is wirelessly transmitted to the router 108, using the first antenna(s) 120, the first modem module 126, the first transceiver 130, etc. That is, as the CPE 106 meshes the signals received across the additional WANs, the CPE 106 may wirelessly transmit a single wireless signal into the premise 102. The fourth signal may therefore represent a RF signal that is transmitted to the router 108 (e.g., the RF signal 204).

Upon receipt of the first signal and the fourth signal, as discussed above, the router 108 may combine the first signal and the fourth signal to provide a network to the consumer device(s) 110. Although the process 500 describes combining signals from two additional WANs, the CPE 106 may be configured to combine signals from more than or less than two additional WANs.

FIG. 6 illustrates an example process 600 for aggregating signals to provide a network to the consumer device(s) 110.

At 602, the process 600 may include receiving, from a first device, a first signal associated with a first portion of broadband services to be provided to a premise. For example, the router 108 may receive, from the CPE 106, the first signal. The first signal may be representative of a conductive signal received via the electrical wiring of the premise 102. For example, in some instances, the router 108 may receive the first signal (conductive signal 202) that represents broadband services to be provided to the premise 102.

At 604, the process 600 may include receiving, from the first device, a second signal associated with a second portion of broadband services to be provided to the premise. For example, the router 108 may receive, from the CPE 106, the second signal. The second signal may be representative of a RF signal wirelessly received from the premise 102. For example, in some instances, the router 108 may receive the second signal (RF signal 204) that represents broadband services to be provided to the premise 102.

At 606, the process 600 may include aggregating the first signal and the second signal. For example, the router 108, or the LAN /WAN aggregator 142 may aggregate the first signal and the second signal to provide a single network to the premise 102. For example, if the first signal provides 100 mbps and the second signal provides 25 mbps, the router 108 may provide the premise 102 with speeds of 125 mbps. In this manner, the router 108 bridges or otherwise combines the first signal and the second signal as a way to increase throughput to the premise 102.

At 608, the process 600 may include providing a LAN to the premise. For example, the router 108 may broadcast, using the second antenna(s) 140, the LAN 206 to the premise 102 for providing the broadband services to the consumer device(s) 110.

While the foregoing invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A device comprising:
a body configured to couple to an electric meter at a premise;
a power module disposed within the body, the power module being configured to couple to electrical wiring at the premise;
an antenna communicatively coupled to the power module;
a broadband over powerline (BPL) interface communicatively coupled to the power module and the antenna;
a wide area network (WAN) mesh component communicatively coupled to the antenna;
one or more processors; and
memory storing computer-executable instructions, that when executed by the one or more processors, cause the device to perform operations comprising:
receiving first data from a first remote device;
receiving second data from a second remote device;
receiving third data from a third remote device;
meshing, via the WAN mesh component, the second data and the third data to generate fourth data;
sending, via the BPL interface, the first data over the electrical wiring to a fourth remote device; and
sending, via the antenna, the fourth data to the fourth remote device.

2. The device of claim 1, wherein:
the fourth remote device comprises at least one of a modem or a router; and
the at least one of the modem or the router is confirmed to aggregate the first data and the fourth data to provide a local area network (LAN) within the premise.

3. The device of claim 1, wherein:
the first data is associated with a first wireless signal received from the first remote device, the first remote device being communicatively coupled to a first WAN;
the second data is associated with a second wireless signal received from the second remote device, the second remote device being communicatively coupled to a second WAN; and
the third data is associated with a third wireless signal received from the third remote device, the third remote device being communicatively coupled to a third WAN.

4. The device of claim 3, wherein:
the second WAN is associated with a first internet protocol; and
the third WAN is associated with a second internet protocol that is the same or different than the first internet protocol.

5. The device of claim 1, the operations further comprising receiving fifth data from a fifth remote device, and wherein meshing, via the WAN mesh component, the second data and the third data to generate fourth data comprises meshing, via the WAN mesh component, the second data, the third data, and the fifth data to generate the fourth data.

6. A system comprising:
a consumer premise equipment (CPE) configured to couple to an electric meter at a premise, the CPE including:
one or more first antennas,
a first broadband over powerline (BPL) interface,
one or more first processors, and
first memory storing computer-executable instructions, that when executed by the one or more first processors, cause the CPE to perform operations comprising:
receiving first data from a first remote device,
receiving second data from a second remote device,
sending, via the first BPL interface, the first data over electrical wiring of the premise, and
sending, via the one or more first antennas, the second data; and a router including:
one or more second antennas,
a second BPL interface,
one or more second processors, and
second memory storing computer-executable instructions, that when executed by the one or more second processors, cause the router to perform operations comprising:
receiving, via the second BPL interface, the first data,
receiving, via the one or more second antennas, the second data, and
aggregating the first data and the second data to generate a local area network (LAN) at the premise.

7. The system of claim 6, wherein:
the first data is associated with a first signal received by the CPE, the first signal being representative of a first portion of broadband internet provided to the premise; and
the second data is associated with a second signal received by the CPE, the second signal being representative of a second portion of the broadband internet provided to the premise.

8. The system of claim 6, wherein the CPE further perform operations comprising:
receiving third data from a third remote device;
meshing the second data and the third data to generate fourth data; and
sending, via the one or more first antennas, the fourth data to the router.

9. The system of claim 6, wherein:
the CPE is located externally to the premise; and
the router is located internally within the premise.

10. The system of claim 6, wherein the CPE further includes a wide area network (WAN) mesh component, the WAN mesh component being configured to mesh one or more WANs external to the premise.

11. The system of claim 6, wherein:
the first data sent by the first BPL interface represents a conductive signal sent to the router over the electrical wiring; and
the second data sent by the one or more first antennas represents a radio frequency (RF) signal sent to the router.

12. The system of claim 6, wherein:
the first data is associated with a first wireless signal received from the first remote device, the first remote device being communicatively coupled to a first WAN; and
the second data is associated with a second wireless signal received from the second remote device, the second remote device being communicatively coupled to a second WAN.

13. The system of claim 6, wherein the router includes a LAN aggregator component, the LAN aggregator component being configured to aggregate the first data and the second data to generate the LAN at the premise.

14. A system comprising:
a consumer premise equipment (CPE) including a first antenna, a first broadband over powerline (BPL) interface, a first modem module, and a first transceiver, the CPE configured to:
wirelessly communicate with a first remote device via the first antenna,
aggregate a plurality of wide area networks (WANs), and
transmit a first signal and a second signal; and
a router including a second antenna, a second PBL interface, a second modem module, and a second transceiver, the router being configured to:
receive the first signal and the second signal,
aggregate the first signal and the second signal to provide a local area network (LAN), and
wirelessly communicate with a second remote device via the second antenna.

15. The system of claim 14, wherein the CPE is configured to:
transmit the first signal, via the first BPL interface, to the second BPL interface using electrical wiring of a premise; and
transmit the first signal, via the first transceiver, to the second transceiver.

16. The system of claim 14, wherein the CPE is configured to:
receive first data from the first remote device; and
receive second data from a third remote device, wherein:
the first signal is associated with the first data, and
the second signal is associated with the second data.

17. The system of claim 16, wherein the CPE is configured to receive third data from a fourth remote device, wherein the second signal is associated with the third data.

18. The system of claim 17, wherein:
the first signal is associated with a first portion of broadband internet provided to a premise; and
the second signal is associated with a second portion of broadband internet provided to the premise.

19. The system of claim 17, wherein:
the first data is associated with a first wireless signal received from the first remote device, the first remote device being communicatively coupled to a first WAN;
the second data is associated with a second wireless signal received from the second remote device, the second remote device being communicatively coupled to a second WAN; and
the third data is associated with a third wireless signal received from the third remote device, the third remote device being communicatively coupled to a third WAN.

20. The system of claim 14, wherein the CPE is configured to couple to an electric meter at a premise for coupling to electrical wiring at the premise.
